(19) United States
(12) Patent Application Publication
(10) Pub. No.: US 2024/0262192 A1
(43) Pub. Date: Aug. 8, 2024

(54) FLEXIBLE DISPLAY OF VEHICLE INFORMATION

(71) Applicant: Ford Global Technologies, LLC, Dearborn, MI (US)

(72) Inventors: Muhannad Hamdan, Canton, MI (US); Mahmoud Y. Ghannam, Canton, MI (US); Bradford S. Bondy, St. Clair Shores, MI (US); Christian Wegner, Grosse Ile, MI (US); John Robert Van Wiemeersch, Novi, MI (US)

(73) Assignee: Ford Global Technologies, LLC, Dearborn, MI (US)

(21) Appl. No.: 18/163,557

(22) Filed: Feb. 2, 2023

(51) Int. Cl. B60K 35/00

(52) U.S. Cl. CPC B60K 35/00; B60K 35/23; B60K 35/28; B60K 35/65; B60K 2360/176; B60K 2360/178; B60K 2360/21; B60K 2360/741

(57) ABSTRACT

A system and method transmits a first signal to display vehicle information in a default location of a vehicle upon an occurrence of a condition, receives data indicative of an adverse visibility condition causing suboptimal perception of the vehicle information in the default location, and transmits a second signal to display the vehicle information in a secondary location.

### BACKGROUND

Driver assistance technology (DAT), such as a blind spot information system (BLIS), is increasingly being provided on vehicles. A BLIS, when active, may display driving information on an outside rear-view mirror. Transparent display heads-up-displays (TD-HUDs) are also coming into use to display information to the user in vehicles. Variable conditions such as light glare on such displays, user positioning, or weather or environmental conditions may affect a user's perception of a display.

### BRIEF DESCRIPTION OF THE DRAWINGS

FIG. 1 is diagram of an example system for the flexible display of vehicle information.

FIG. 2 is an example outside rear-view mirror with a display of BLIS vehicle information.

FIG. 3A is an example vehicle interior with a TD-HUD display area and a center stack display.

FIG. 3B is an example diagram of a TD-HUD.

FIG. 4A is an example of a TD-HUD display area.

FIG. 4B is an example TD-HUD display area with BLIS video images.

FIG. 5 is an example TD-HUD display area with repositioned vehicle information.

FIG. 6 is an example flow diagram for a process of flexibly displaying vehicle information.

### DETAILED DESCRIPTION

A vehicle may include various interfaces for the display of information to a user such as a driver or operator, or other occupant. The present disclosure describes systems and methods that include various sensors and cameras to determine when the visibility of vehicle information displayed on an outside rear-view mirror or TD-HUD may be suboptimal due to an adverse visibility condition such as glare, weather conditions, or user mobility. When visibility is suboptimal in a default location, the vehicle information is displayed on an additional display in another location that is not subject to an adverse visibility condition.

In one or more implementations of the present disclosure, a system may include a computer having a processor and a memory, the memory storing instructions executable by the processor programmed to: transmit a first signal to display vehicle information in a default location of a vehicle upon an occurrence of a condition; receive data indicative of an adverse visibility condition causing suboptimal perception of the vehicle information in the default location; and transmit a second signal to display the vehicle information in an additional secondary location.

In an implementation, the adverse visibility condition may be: sun glare or headlight glare on an outside rear-view mirror or a transparent display heads-up display (TD-HUD), weather-impeded visibility of the outside rear-view mirror; or user-mobility impeded visibility of the outside rear-view mirror.

In another implementation, the data may include a vehicle location and travel direction, a sun position, a weather condition, an oncoming headlights position, a following headlights position, a user's range of motion, and/or a user's eye position.

In a further implementation, the data may be global positioning system (GPS) data, sun load data, weather condition data, time of day, auto-dimming rearview mirror data, calculated sun position data, forward-facing camera data, rear-facing camera data, and/or user-facing camera data.

In an implementation, the system may include instructions executable by the processor to determine the adverse visibility condition causing suboptimal perception of the vehicle information using an artificial intelligence (AI) or a machine learning (ML) algorithm.

In another implementation, the vehicle information may be a blind spot notification from a blind spot information system (BLIS); the default location may be an outside rear-view mirror; and the additional secondary location may be an infotainment display, and instrument panel display, or a transparent display heads-up display (TD-HUD).

In a further implementation, the vehicle information may be displayed in multiple secondary locations.

In yet another implementation, a default location may be a transparent display heads-up display (TD-HUD), and the additional secondary location may be an instrument panel display or an infotainment display.

In a further implementation, the vehicle information in the default location of the TD-HUD may also be repositioned to a different position in the TD-HUD.

In an implementation, the system may include instructions to receive input of a user-selection specifying the secondary location for the vehicle information and receive data to identify the user for application of the user-selection during operation of the vehicle by the user.

In one or more implementations of the present disclosure, a method may include: transmitting a first signal to display vehicle information in a default location of a vehicle upon an occurrence of a condition; receiving data indicative of an adverse visibility condition causing suboptimal perception of the vehicle information in the default location; and transmitting a second signal to display the vehicle information in an additional secondary location.

In an implementation of the method, the adverse visibility condition may be: sun glare or headlight glare on an outside rear-view mirror or a transparent display heads-up display (TD-HUD); weather-impeded visibility of the outside rear-view mirror; or user-mobility impeded visibility of the outside rear-view mirror.

In another implementation of the method, the data may include a vehicle location and travel direction, a sun position, a weather condition, an oncoming headlights position, a following headlights position, a user's range of motion, and/or a user's eye position.

In a further implementation of the method, the data may be global positioning system (GPS) data, sun load data, weather condition data, time of day, auto-dimming rearview mirror data, calculated sun position data, forward-facing camera data, rear-facing camera data, and/or user-facing camera data.

In an implementation, the method may further include determining the adverse visibility condition causing suboptimal perception of the vehicle information using an artificial intelligence (AI) or a machine learning (ML) algorithm.

In another implementation of the method, the vehicle information may be a blind spot notification from a blind spot information system (BLIS); a default location may be an outside rear-view mirror; and the additional secondary location may be an infotainment display, and instrument panel display, or a transparent display heads-up display (TD-HUD).

In a further implementation of the method, the vehicle information may be displayed in multiple secondary locations.

In an implementation of the method, a default location may be a transparent display heads-up display (TD-HUD), and the additional secondary location may be an instrument panel display or an infotainment display.

In another implementation of the method, the vehicle information in the default location of the TD-HUD may also be repositioned to a different position in the TD-HUD.

In a further implementation, the method may further include receiving input of a user-selection specifying the secondary location for the vehicle information, and receiving data to identify the user for application of the user-selection during operation of the vehicle by the user.

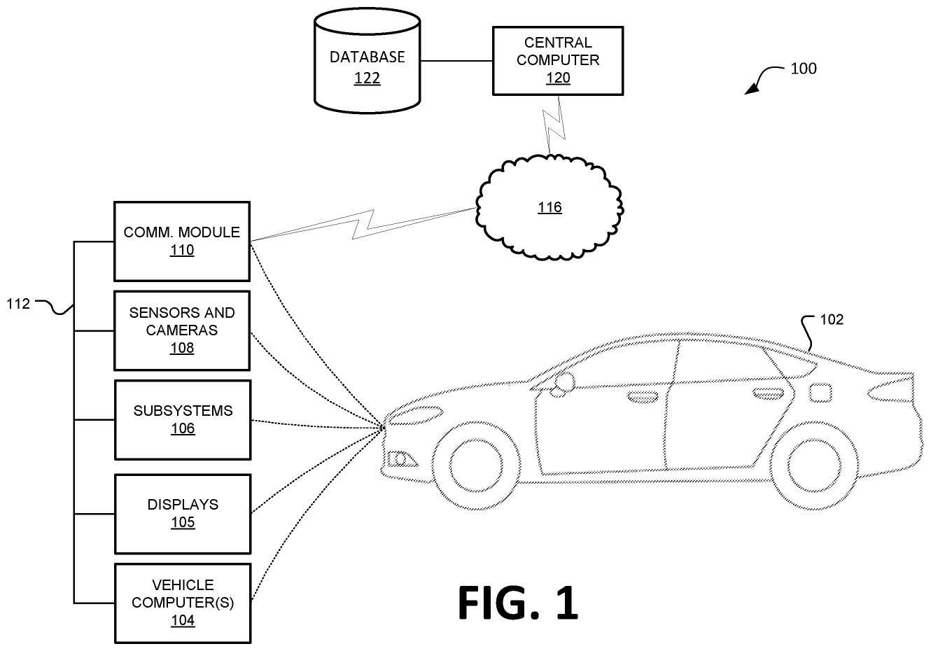

With reference to FIG. 1, a connected vehicle system 100 can provide communications between a vehicle 102 and a central computer 120 to share data.

Vehicle 102 is a set of components or parts, including hardware components and typically also software and/or programming, to perform a function or set of operations in the vehicle 102. Vehicle subsystems 106 typically include a braking system, a propulsion system, and a steering system as well as other subsystems including but not limited to an advanced driver assist system (ADAS), a body control system, a climate control system, a lighting system, and a human-machine interface (HMI) system, which may include a heads-up display (HUD), an instrument panel, and infotainment system, as will be discussed further, below. The propulsion subsystem converts energy to rotation of vehicle 102 wheels to propel the vehicle 102 forward and/or backward. The braking subsystem can slow and/or stop vehicle 102 movement. The steering subsystem can control a yaw, e.g., turning left and right, maintaining a straight path, of the vehicle 102 as it moves.

Computers, including the herein-discussed one or more vehicle computers 104, (e.g., one or more electronic control units (ECUs), and central computer 120 include respective processors and memories. A computer memory can include one or more forms of computer readable media, and stores instructions executable by a processor for performing various operations, including as disclosed herein. For example, the computer can be a generic computer with a processor and memory as described above and/or an ECU, controller, or the like for a specific function or set of functions, and/or a dedicated electronic circuit including an ASIC that is manufactured for a particular operation, e.g., an ASIC for processing sensor data and/or communicating the sensor data. In another example, computer may include an FPGA (Field-Programmable Gate Array) which is an integrated circuit manufactured to be configurable by a user. Typically, a hardware description language such as VHDL (Very High-Speed Integrated Circuit Hardware Description Language) is used in electronic design automation to describe digital and mixed-signal systems such as FPGA and ASIC. For example, an ASIC is manufactured based on VHDL programming provided pre-manufacturing, whereas logical components inside an FPGA may be configured based on VHDL programming, e.g., stored in a memory electrically connected to the FPGA circuit. In some examples, a combination of processor(s), ASIC(s), and/or FPGA circuits may be included in a computer.

A computer memory can be of any suitable type, e.g., EEPROM, EPROM, ROM, Flash, hard disk drives, solid state drives, servers, or any volatile or non-volatile media. The memory can store data, e.g., a memory of an ECU. The memory can be a separate device from the computer, and the computer can retrieve information stored in the memory, e.g., one or more computers 104 can obtain data to be stored via a vehicle network 112 in the vehicle 102, e.g., over an Ethernet bus, a CAN bus, a wireless network, etc. Alternatively, or additionally, the memory can be part of the computer, i.e., as a memory of the computer or firmware of a programmable chip.

The one or more vehicle computers 104 (e.g., one or more ECUs) can be included in a vehicle 102 that may be any suitable type of ground vehicle 102, e.g., a passenger or commercial automobile such as a sedan, a coupe, a truck, a sport utility, a crossover, a van, a minivan, etc. As part of a driver assist system or an advanced driver assist system (ADAS), a vehicle computer 104 may include programming to operate one or more of vehicle 102 brakes, propulsion (e.g., control of acceleration in the vehicle 102 by controlling one or more of an internal combustion engine, electric motor, hybrid engine, etc. and control power delivery therefrom), steering, climate control, interior and/or exterior lights, etc., as well as to determine whether and when the computer, as opposed to a human operator, is to control such operations, such as by sending vehicle data over the vehicle network 112. Additionally, a vehicle computer 104 may be programmed to determine whether and when a human operator is to control such operations.

Vehicle computer 104 may include or be communicatively coupled to, e.g., via a vehicle network 112 such as a communications bus as described further below, more than one processor, e.g., included in sensors and cameras 108, electronic controller units (ECUs) or the like included in the vehicle 102 for monitoring and/or controlling various vehicle components, e.g., a powertrain controller, a brake controller, a steering controller, etc. The computer is generally arranged for communications on a vehicle 102 communication network that can include a bus in the vehicle 102 such as a controller area network (CAN) or the like, and/or other wired and/or wireless mechanisms. Alternatively, or additionally, in cases where the computer actually includes a plurality of devices, the vehicle network 112 may be used for communications between devices represented as the computer in this disclosure.

The vehicle network 112 is a network via which messages can be exchanged between various devices in vehicle 102. The vehicle computer 104 can be generally programmed to send and/or receive, via vehicle network 112, messages to and/or from other devices in vehicle 102 e.g., any or all of ECUs, sensors, cameras, actuators, components, communications module, a human machine interface HMI, etc. Additionally, or alternatively, messages can be exchanged among various such other devices in vehicle 102 via a vehicle network 112. In cases in which the vehicle computer 104 includes a plurality of devices, vehicle network 112 may be used for communications between devices represented as a computer in this disclosure. In some implementations, vehicle network 112 can be a network in which messages are conveyed via a vehicle 102 communications bus. For example, vehicle network 112 can include a controller area network (CAN) in which messages are conveyed via a CAN bus, or a local interconnect network (LIN) in which messages are conveyed via a LIN bus. In some implementations, vehicle network 112 can include a network in which messages are conveyed using other wired communication technologies and/or wireless communication technologies e.g., Ethernet, Wi-Fi, Bluetooth, Ultra-Wide Band (UWB), etc. Additional examples of protocols that may be used for communications over vehicle network 112 in some implementations include, without limitation, Media Oriented System Transport (MOST), Time-Triggered Protocol TTP, and FlexRay. In some implementations, vehicle network 112 can represent a combination of multiple networks, possibly of different types, that support communications among devices in vehicle 102. For example, vehicle network 112 can include a CAN in which some devices in vehicle 102 communicate via a CAN bus, and a wired or wireless local area network in which some device in vehicle 102 communicate according to Ethernet or WI-FI communication protocols.

The vehicle computer 104 and/or central computer 120 can communicate via a wide area network 116. Further, various computing devices discussed herein may communicate with each other directly, e.g., via direct radio frequency communications according to protocols such as Bluetooth or the like. For example, a vehicle 102 can include a communication module 110 to provide communications with devices and/or networks not included as part of the vehicle 102, such as the wide area network 116, for example. The communication module 110 can provide various communications, e.g., vehicle to vehicle (V2V), vehicle-to-infrastructure or everything (V2X) or vehicle-to-everything including cellular communications (C-V2X) wireless communications cellular, dedicated short range communications (DSRC), etc., to another vehicle or infrastructure typically via direct radio frequency communications and/or typically via the wide area network 116, e.g., to the central computer 120. The communication module 110 could include one or more mechanisms by which a vehicle computer 104 may communicate, including any desired combination of wireless e.g., cellular, wireless, satellite, microwave and radio frequency communication mechanisms and any desired network topology or topologies when a plurality of communication mechanisms are utilized. Exemplary communications provided via the module can include cellular, Bluetooth, IEEE 802.11, DSRC, cellular V2X, CV2X, and the like.

A vehicle 102 in accordance with the present disclosure includes a plurality of sensors and cameras 108 that may support the driver assist or ADAS functions. For example, sensors and cameras 108 may include, but are not limited to, one or more wheel speed sensor, steering angle sensor, GPS sensor, driver-facing camera, back-seat camera, forward-facing camera, side-facing camera, rear-facing camera, ultrasonic parking assist sensor, short range RADAR, medium range RADAR, LiDAR, light sensor, rain sensor, accelerometer, wheel torque sensors, inertial sensor, yaw rate sensor, etc. Sensors and cameras 108 can support functions that uses cameras to detect lane lines and road curvature, sometimes in conjunction with detailed mapping data. Sensors and cameras 108 may also support a lane keep assist (LKA) or lane centering assist (LCA) function that uses one or more cameras to detect lane lines and a steering angle sensor or support a drive assist function that uses one or more cameras to detect lane lines or monitor blind spots as part of the BLIS, a steering angle or position sensor, and a driver monitoring system camera (DMSC). Sensors and cameras 108 may also support an adaptive cruise control (ACC) function that uses wheel speed sensors/GPS and/or cameras/medium range RADAR/LiDAR to support an automatic follow distance function. Sensors and cameras 108 may also support an intelligent adaptive cruise control (iACC) function that uses accelerometers, wheel speed sensors/GPS, cameras, and/or RADAR/LiDAR to support cruise control functions that alter vehicle speed based upon detected speed limits, accelerations, and road curvature. Sensors and cameras 108 can support a parking assist function that uses steering sensors, cameras, and/or ultrasonic sensors.

In some of these operations, sensors and cameras 108 such as a camera, RADAR sensor, ultrasonic sensor, and/or LiDAR sensor of the vehicle 102 may detect the position and height of objects relative to the position, height, and angle of the sensor and cameras 108 mounted on the body of vehicle 102, including but not limited to the position of lane lines, curbs, overhead signs, speed limit signs, overpasses, and other vehicles, including those in a driver's blind spots in accordance with the BLIS operation.

A vehicle 102 in accordance with the present disclosure includes one or more driver assist systems that provide notifications to a user to support the user assist operation. While such notifications may include audible and/or haptic components, the present disclosure is drawn to the visual components of such notifications. Driver assist systems can rely on data from sensors and cameras 108 for various operations, including determining input such as a vehicle speed, vehicle steering angle, input concerning proximate objects, other vehicles, etc.

A vehicle 102 in accordance with the present disclosure includes displays 105 to display information to the user. The displays 105 may include various types of displays, including a portion of an outside rear-view mirror in which a notification may be displayed, such as by illumination of a light, an instrument panel cluster or portion thereof including a flat-panel display (e.g., LED, OLED, LCD, AMOLED, etc.), a heads-up display such as a transparent display heads-up display (TD-HUD), and a flat-panel display screen in a center stack of vehicle 102 used for infotainment and/or climate controls and which may be part of a human-machine interface (HMI). The HMI of displays 105 may also include one or more means for inputting data from a user. The displays 105 may be connected to one or more vehicle computer 104 (e.g., ECU) via the vehicle network 112 and may receive signals to display various data, including notifications that include vehicle information.

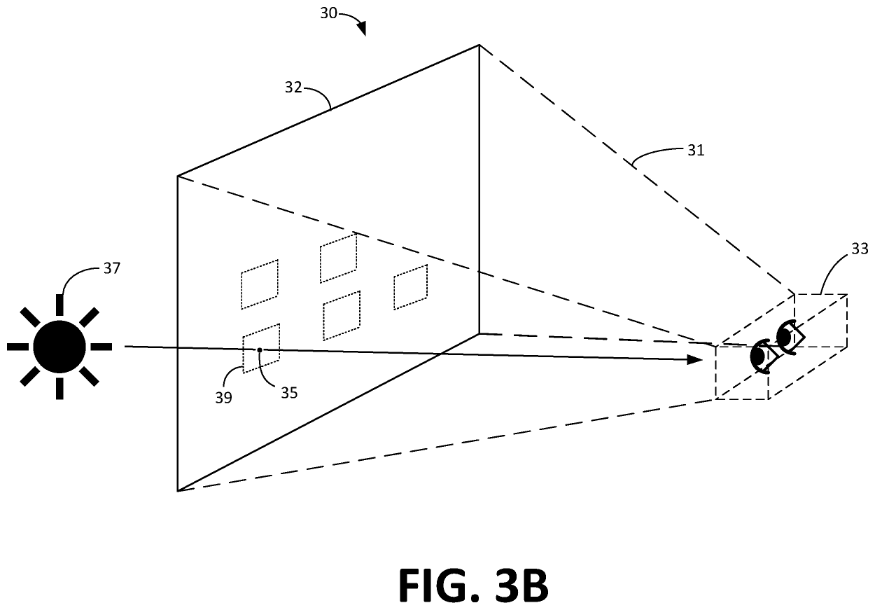

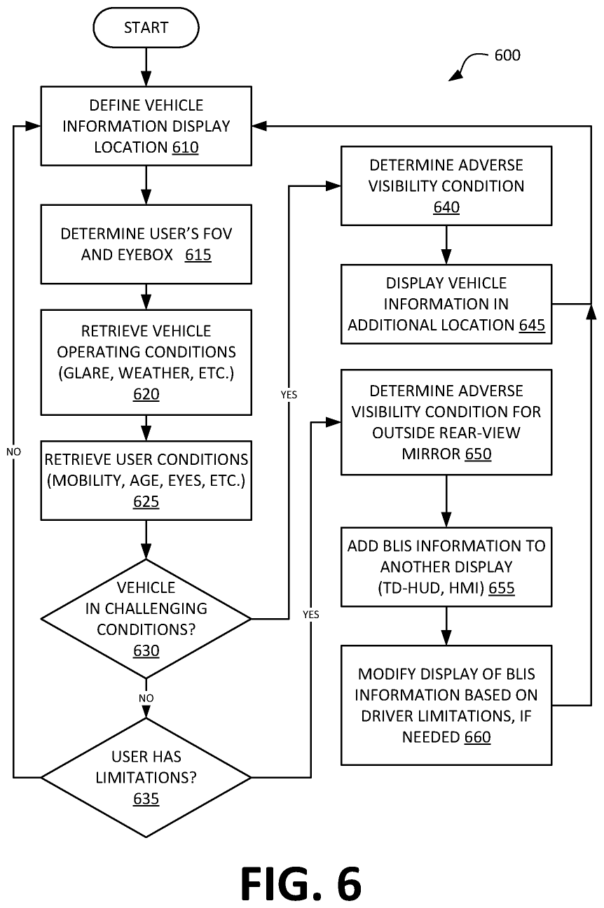

A central computer 120 may be connected to a database 122. Data may be received by central computer 120 over wide area network 116 from communication module 110 of vehicle 102 and stored in database 122 to be accessed and used by central computer 120. Data from vehicle 102 may include global positioning system (GPS) data, sun load data, weather condition data, time of day, auto-dimming rearview mirror data, calculated sun position data, forward-facing camera data, rear-facing camera data, and/or user-facing camera data that may be used to determine an adverse visibility condition, as described further with respect to FIGS. 3A, 3B, and 6. In an implementation, the data may be used by a vehicle computer 104 or central computer 120 to determine the adverse visibility condition that may be impeding or otherwise causing suboptimal perception of displayed vehicle information by the user using an artificial intelligence (AI) or a machine learning (ML) algorithm.

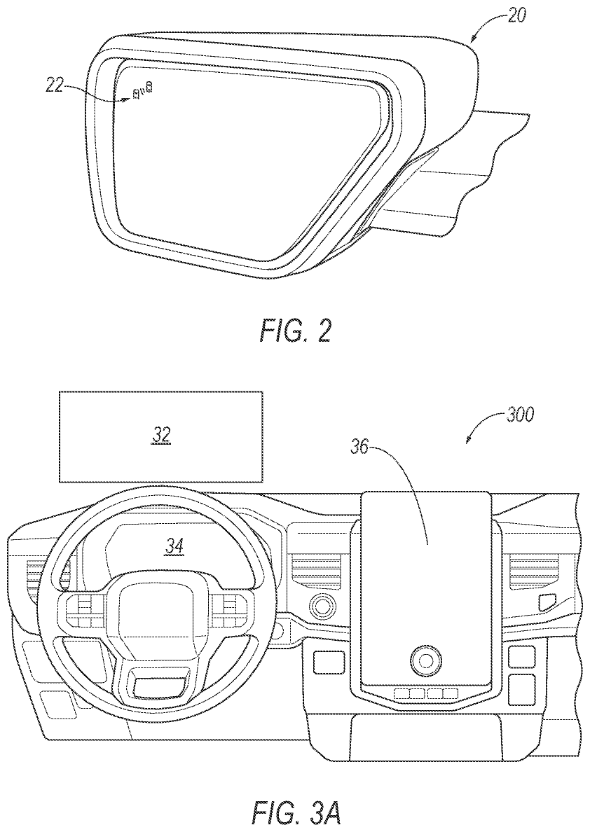

With reference to FIG. 2, an example of an outside rear-view mirror 20 of vehicle 102 is illustrated. While shown as a left-side mirror, vehicle 102 may additionally include a corresponding right-side mirror (not shown) having the same features.

Outside rear-view mirror 20 includes a portion 22 that may be illuminated or otherwise displayed if the vehicle 102 has BLIS activated to provide a notification to a user. In accordance with operation of a BLIS feature, the notification may be a symbol representing the presence of another vehicle in a blind spot of the user, but implementations are not limited thereto and may include other mirror-based notifications without departing from the present disclosure. However, since the mirror surface of outside rear-view mirror 20 is reflective and typically not protected by any shading mechanism, it can be subject to bright glare from the sun or from bright headlights that are behind the vehicle 102. Additionally, the mirror surface of outside rear-view mirror 20 or any other surface thereof providing a BLIS notification may be exposed to environmental conditions that may obscure the surface, such as snow, ice (including frost), salt spray, mud, fog (i.e., condensation), dirt, sand, and/or rain. Moreover, as the outside rear-view mirror 20 is located laterally relative to a user, a user may require mobility, e.g., an ability to turn, in order to properly view the outside rear-view mirror 20.

With reference to FIG. 3A, an example of an interior 300 of vehicle 102 adjacent to a driver seat is illustrated.

A vehicle 102 in accordance with the present disclosure includes a transparent display heads-up display (TD-HUD). A display area 32 of the TD-HUD is disposed in front of the user and within the user's field of view (FOV) between the user and the windscreen. The TD-HUD may include, for example, a digital light projector (DLP) projecting onto a transparent base substrate or the windscreen to provide the transparent display area 32, as will be understood. However, since the display area 32 of TD-HUD is transparent and not protected by any shading mechanism, it can be subject to bright glare from the sun (or sun reflection) or from bright headlights that are in front of the vehicle 102, as discussed further with respect to FIG. 3B.

A vehicle 102 in accordance with the present disclosure may include an instrument panel cluster (IPC) 34 provided in a shaded position in front of the user. The IPC 34 may include a portion that includes a flat-panel display that may be configurable (i.e., a user may be able to select content for the display at various times or on various events, and/or may be able to control presentation attributes such as color contrast, brightness, etc.). The IPC 34, if provided, may not include a full instrument panel cluster since the vehicle 102 includes a TD-HUD display area 32 for displaying the information typically provided by an instrument panel cluster. Accordingly, IPC 34 may have a smaller display area so as to provide a backup display of certain information.

A vehicle 102 in accordance with the present disclosure further includes a center stack display 36. Center stack display 36 may be a flat-panel display screen (e.g., LED, OLED, LCD, AMOLED, etc.) and may include a touch sensing layer so as to act as a touch screen. Alternately or additionally, the center stack display 36 may have physical controls for user input.

With a plurality of display screens in the form of the display area 32 of the TD-HUD, the IPC 34, and the center stack display 36 in the interior 300 of vehicle 102 proximate to so as to be viewable from a driver seat, when display area 32 of TD-HUD or outside rear-view mirror 20 is subject to glare or other adverse visibility condition, vehicle information may be additionally displayed on an alternate display upon determining that the usual display location of the display area 32 of TD-HUD or outside rear-view mirror 20 has an adverse visibility condition.

With reference to FIG. 3B, a diagram illustrates example operation a TD-HUD 30. With respect to a TD-HUD 30, any suitable technique such as a known technique for detecting a user's gaze direction and/or a user pose, and then determining how to position elements 39 on a virtual image displayed on a display area 32 of a TD-HUD 30. See, for example, Khan et al., Gaze and Eye Tracking: Techniques and Applications in ADAS, Sensors (Basel), 2019 Dec. 14; 19(24):5540, doi: 10.3390/s19245540, PMID: 31847432; PMCID: PMC6960643; Shah et al., A Driver Gaze Estimation Method Based on Deep Learning, Sensors (Basel), 2022 May 23; 22(10):3959, doi: 10.3390/s22103959, PMID: 35632365; PMCID: PMC9142909; and Wang et al., Driver's Head Pose and Gaze Zone Estimation Based on Multi-Zone Templates Registration and Multi-Frame Point Cloud Fusion, Sensors (Basel), 2022 Apr. 20; 22(9):3154, doi: 10.3390/s22093154, PMID: 35590843; PMCID: PMC9105416.

The display area 32 may be mapped to a suitable coordinate system usable for positioning of elements 39 of the virtual display within the display area 32. An element 39 is a set of information or content where the information or content in the set is to be presented or displayed together. For example, an element 39 could display vehicle data such as a current speed and/or a current vehicle compass heading of vehicle 102.

Typically, TD-HUD 30 includes a digital light projector (DLP) (not shown), with or without mirrors, to project a virtual image onto a transparent display surface to provide a display area 32 of a TD-HUD 30. As noted above, the transparent display surface may be part of a windscreen or a separate transparent base substrate, and may include holographic optical elements (HOEs) in some implementations so as to provide a virtual image distance (VID), as will be understood. The positioning of elements 39 in the display area 32 may be based on a defined field of view (FOV) 31 and an eyebox 33. As used herein, the FOV 31 is defined by horizontal and vertical dimensions or boundaries, typically specified in degrees with an origin at the user's eyes (e.g., a center point of a line between a user's eyes), that determines the size of a display area 32, and the eyebox 33 is the three-dimensional region in which a user can see an entire projected display of the virtual image when moving their head to various positions.

For example, as will be understood, various sensors and cameras 108 may be used to determine a location (e.g., according to a coordinate system mapped to the vehicle 102 interior and including the display area 32) of a user's eyes relative to the display area 32. The location of the user's eyes may then be used to determine the user's FOV 31 for display of elements 39 projected onto a transparent surface in a display area 32 to an eyebox 33. Mirrors or the like (not shown) may be used to adjust the projection of elements 39 to eyeboxes 33 of different heights (based on different user heights) so as to maintain alignment of the elements 39 of the virtual image within the coordinate system of the display area 32 of TD-HUD 30.

Because the surface providing the display area 32 is transparent, conditions may occur wherein a bright light source 37, such as the sun, a sun reflection, or a bright headlight, will be visible within display area 32 to a user at eyebox 33. For example, as illustrated in FIG. 3B, a light ray 35 from the bright light source 37 may pass through an element 39 of a virtual image on its way to a user's eyes in the eyebox 33. When such rays from the bright light source 37 exceed a threshold brightness or a threshold brightness difference relative to ambient brightness conditions to which a user's eyes have adjusted to, the bright light source 37 may cause an adverse visibility condition. Various sensors and cameras 108 may be used for determining an ambient brightness and a brightness of the bright light source 37.

In addition to using the user's pose and gaze direction for operation of the TD-HUD 30, the data used for determining the FOV 31 and eyebox 33 may also indicate a location of the user's eyes for use in later determinations of a possible adverse visibility condition based on user limitations. In an implementation, an onboard artificial intelligence (AI) or a machine learning (ML) algorithm may be used, such as by employing the techniques of Khan et al., Shah et al., or Wang et al., to track a user and realize the gaze direction limitations of the user's eyes with the assistance of onboard cameras. Such gaze data may be used, for example, to determine that a user has limitations related to use of an outside rear-view mirror if the gaze data indicates that the user's gaze directions does not include a direction of an outside rear-view mirror.

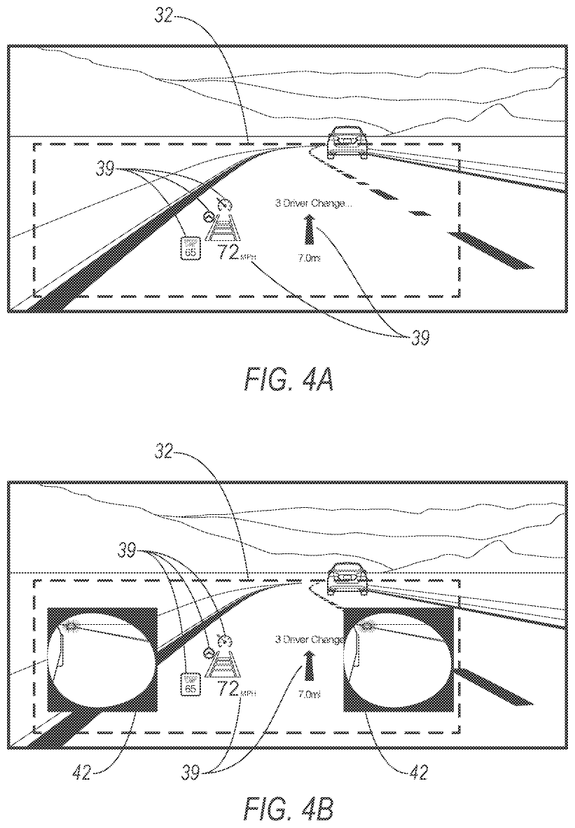

With reference to FIGS. 4A and 4B, an example of a display area 32 of a TD-HUD is illustrated to show the standard display in FIG. 4A and its use as an additional display for BLIS vehicle information in FIG. 4B upon the determination of an adverse visibility condition related to outside rear-view mirror 20.

In FIG. 4A, the display area 32 of a TD-HUD displays elements 39 having information such as the current speed limit, the current speed, the activation of lane keep assist, the activation of cruise control, and navigational instructions in predetermined locations.

In FIG. 4B, upon a determination that outside rear-view mirror 20 has an adverse visibility condition, the display area 32 of the TD-HUD displays elements 39 having the current speed limit, the current speed, the activation of lane keep assist, the activation of cruise control, navigational instructions, and additional vehicle information in the form of BLIS video images 42. Although not shown in FIGS. 4A and 4B, despite the determination that outside rear-view mirror 20 has an adverse visibility condition, BLIS information can remain displayed on outside rear-view mirror 20, typically in an augmented fashion, such as by illumination of the BLIS notification on portion 22.

In an alternate implementation, the positions of BLIS video images 42 may instead be used to duplicate the illuminated BLIS indicator from the outside rear-view mirror 20 onto the display area 32 of TD-HUD so as to keep the display of the TD-HUD uncluttered, yet still permit user perception of the vehicle information.

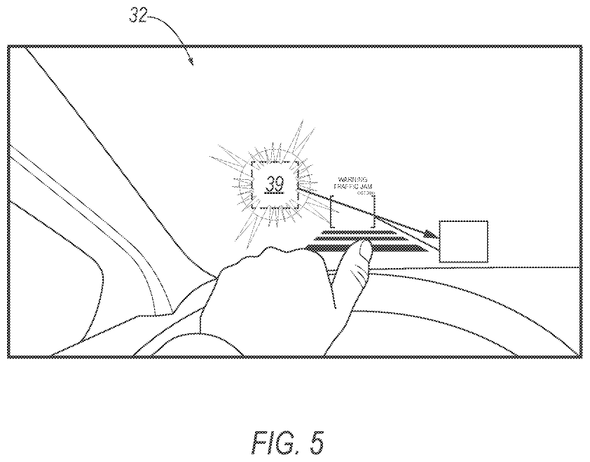

With reference to FIG. 5, an example of a display area 32 of a TD-HUD that is subject to an adverse visibility condition of sun glare is illustrated.

In an implementation, a computer 104 or 120 may determine that at least a portion of display area 32 is subject to an adverse visibility condition based upon sun glare behind a display element 39 (e.g., a display element showing a navigation map in the illustrated example) projected by the TD-HUD. In accordance with the present disclosure, the vehicle information of display element 39 may be displayed on an additional display, such as IPC 34 or center stack display 36. The vehicle information from display element 39 may be presented in an alternative form when displayed on an additional display in order to account for physical differences in the displays or may be displayed in the same form when the additional display allows.

Additionally, as illustrated in FIG. 5, the affected display element 39 may be repositioned within the display area 32 to a location that is not subject to an adverse visibility condition, i.e., not subject to the sun glare associated with the original location of display element 39 within the display area 32. Repositioning may use the coordinate system of display area 32 to translate the display element 39 to coordinates within the display area 32 that have been determined to not be subject to the adverse visibility condition. Such a repositioning may help a user keep their eyes on the road, but the additional display on another display may further assist the user when the glare has caused the user to avert their gaze or has caused a temporary blind spot that obstructs part of the user's vision.

With reference to FIG. 6, an example process 600 for flexible display of vehicle information is illustrated. Typically, the process 600 will be performed by one (or possibly more) vehicle computers 104 (e.g., one or more ECUs). However, in certain implementations, various blocks of process 600 may be performed at central computer 120, with or without the assistance of an artificial intelligence (AI) or a machine learning (ML) algorithm.

In a first block 610, a computer 104 defines a vehicle information display location. This vehicle information display location is a default location on a default display. For example, for the BLIS information, the default location may be portion 22 and the default display may be the corresponding outside rear-view mirror 20 on a side of vehicle 102 in which another vehicle has entered a blind spot. For the lane-keep assist information, for example, the default location may be a lower central portion of a virtual image of a TD-HUD 30 and the default display may the display area 32 of the TD-HUD 30. In an implementation, a vehicle 102 may include a default configuration file for use by the computer 104 in block 610. In another implementation, a vehicle 102 may permit a user to define a default location on a default display, which may then be saved in a configuration file for use by the computer 104 in block 610.

In a next block 615, a computer 104 determines the field of view (FOV) 31 of the user's eyes and an eyebox 33, as is typically done for alignment and positioning of elements 39 on a coordinate system of display area 32 of a TD-HUD 30. visibility condition

In a block 620, a computer 104 or central computer 120 retrieves data related to vehicle operating conditions. This data may include a vehicle location and travel direction, a sun position, a weather condition, an oncoming headlights position, and/or a following headlights position. Various sensors and cameras 108 may be used to acquire this data, including GPS sensors for the vehicle location and travel direction, sun-load sensors for sun position and/or weather conditions, auto-dimming mirror sensors for sun position, weather conditions, and/or following headlights position, and cameras on the vehicle 102 for sun position, weather conditions, an oncoming headlights position, and/or a following headlights position.

In a block 625, a computer 104 or central computer 120 retrieves data related to user conditions, which may be from a stored profile associated with the user and/or from real-time images. This data may include a user's range of motion based on age or injury, a user's condition, and/or a user's eye position. User input as well as various sensors and cameras 108 may be used to acquire this data, including eye-tracking sensors and/or user monitoring cameras on the vehicle 102. Upon user input of a permanent condition (e.g., cervical fusion, etc.) and/or data collection using eye-tracking sensors and/or user monitoring cameras, a sensor may recognize a user's fob or a camera may recognize a user's face, and save the data in a profile associated with the user for future retrieval.

For example, an interior camera may capture an image of the user with a condition. However, a retrieved profile based on recognizing the user (by fob or facial recognition) may not indicate any user conditions. Image recognition performed on the captured image may then be used to determine that the user has the condition. Based upon a generic profile for those with an identified condition, the computer 104 may retrieve data related to the mobility limitations associated with the condition as impeding the visibility of an outside rear-view mirror, and update the user's profile to indicate this temporary user condition. The temporary user condition stored in the user profile may then be revised or deleted later based upon additional tracking data and/or user input.

In a block 630, a computer 104 or central computer 120 determines whether a vehicle 102 is in challenging conditions. Challenging conditions may include an accumulation of snow, ice, salt spray, mud, heavy rain, sand, or fog on an outside rear-view mirror 20, heavy rain/snow/sand/fog, bright sun glare, bright headlight glare, etc.

For example, accumulation of snow, ice, etc. on an outside rear-view mirror may be determined based on data from cameras, as well as data from sensors such as auto-dimming sensors as compared to sun load sensors or other auto-dimming sensors. For example, if a sun load sensor or inside mirror auto-dimming sensor indicates bright lighting conditions and an outside rear-view mirror auto-dimming sensor indicates darker conditions exceeding a threshold difference, the outside rear-view mirror may be covered in mud, snow, or salt spray. Heavy rain/snow/sand/fog or bright sun glare may be determined based on camera data, sun load data, GPS data in combination with weather data and/or time of day data, and/or auto-dimming mirror data. For example, GPS data may indicate travelling in a northern direction, with weather and time data indicating an overcast afternoon, and camera data indicating moderate light conditions not exceeding any threshold level. In such a case, each condition is indicative of a lack of challenging conditions such that an algorithm may determine “no” at block 630. Alternately, the algorithm may determine “yes” as to whether the vehicle 102 is operating under challenging conditions based upon GPS data indicating travel in an eastern direction, weather and time data indicating a clear morning near sunrise, and camera data indicating high dynamic range with a brightness level exceeding a threshold level. Bright headlight glare may be determined based upon camera data and/or auto-dimming mirror data. For example, brightness levels from camera data and/or auto-dimming mirror data be compared to a predetermined threshold level, with a determination of “yes” upon a brightness level exceeding the threshold level and a determination of “no” upon a brightness level not exceeding the threshold level.

Accordingly, data related to vehicle operating conditions from block 620 may be used to determine whether a vehicle is in challenging conditions at block 630 by comparison of the collected data to various thresholds. Thresholds for various conditions typically can be determined empirically, i.e., by driving a vehicle 102 in a test environment or on an actual road, recording conditions that would be identified as challenging, and then determining when vehicle sensor data indicates that challenging conditions exist, i.e., when one or more thresholds that define a challenging condition are triggered. For example, a sun load threshold could be established such that when sensor data indicates that detected sunlight exceeds a specified amount of light, e.g., in lumens, a challenging condition could be determined to exist warranting adjustment of a display position. The sun load threshold could further take into account a sun angle threshold with respect to an orientation of the vehicle 102, e.g., a forward-facing orientation. That is, a challenging condition could be determined to exist based on a sun load exceeding a threshold and alternatively or additionally according to a sun angle threshold exceeding or falling below a threshold, e.g., an angle of a longitudinal axis of the vehicle 102 to a point on the horizon directly below a position of the sun. A challenging condition could yet further alternatively or additionally be determined based on a sun azimuth angle, i.e., a height of the sun with respect to the horizon. In other words, a challenging condition could be defined based on thresholds that have been determined to indicate that sun glare is likely present for an operator and/or other user of a vehicle. Similarly, a challenging condition could be determined to exist based on detecting a brightness and/or direction of lamps of another vehicle, e.g., an oncoming vehicle.

If the determination of whether the vehicle 102 is in challenging conditions is “no”, in a block 635, a computer 104 or central computer 120 determines whether a user has limitations based on the user condition(s) data received at block 625. Limitations may include a user lacking sufficient mobility or visual capability to view one or both outside rear-view mirrors 20 or the center stack display 36 without difficulty. If the determination of whether the user has limitations is “no”, the process 600 returns to block 610 (or block 615) to continue the process 600 in case vehicle or user conditions change.

If the determination of whether the vehicle 102 is in challenging conditions is “yes”, in a block 640, a computer 104 or central computer 120 performs the additional processing required to determine an occurrence of an adverse visibility condition that impedes or otherwise causes the user's visual perception of the vehicle information to be suboptimal. In this manner, the additional processing required to determine an occurrence of an adverse visibility condition is performed only when the vehicle operating conditions warrant it. In other words, if a challenging condition has been determined to exist, as described above with respect to the block 630, it may then be determined in the block 640 whether that challenging condition creates an adverse visibility condition for a current vehicle user, for example, by a determination that light ray 35 of a bright light source 37 is sufficiently bright to adversely affect visibility of element 39 to a user's eyes in eyebox 33 of TD-HUD 30 in FIG. 3B. In an implementation, a computer 104 or the central computer 120 may determine the adverse visibility condition impeding or otherwise causing suboptimal perception of the vehicle information, such as by using an artificial intelligence (AI) or a machine learning (ML) algorithm (e.g., such as are known for using eye/gaze tracking to determine a user squinting or looking away), or by using rules-based criteria based on thresholds for various parameters (e.g., light intensity thresholds at certain angles/positions relative to a user's eyebox).

The determination of an adverse visibility condition in the block 630 may vary based upon one or more challenging conditions present at a time of determining the adverse visibility condition. For example, in the case of BLIS information displayed on an outside rear-view mirror, camera data or data from an auto-dimming mirror containing brightness data (e.g., brightness in lux or lumens) may indicate that a threshold brightness of light incident on the outside rear-view mirror has been exceeded so as to trigger the determination of an adverse visibility condition of glare. In another example, camera data may confirm that mud/snow/etc. is obscuring the BLIS information so as to trigger the determination of an adverse visibility condition of occlusion. In the case of vehicle information displayed on a TD-HUD, more complex calculations may be required to determine if the sun, a sun reflection, or a bright headlight is sufficiently bright and disposed in a position such that light passes through elements of the TD-HUD on the way to the user's eyes. Various sensors and cameras may be used to determine a location of a bright light source relative to the user's eyes or eyebox of the TD-HUD, for example by triangulation, in order to determine if the bright light passes through elements of the display area so as to trigger the determination of an adverse visibility condition of glare.

In a next block 645, a computer 104 may display vehicle information being displayed in a display subject to an adverse visibility condition in an additional display that is not subject to the adverse visibility condition. For example, BLIS information being displayed in an outside rear-view mirror 20 subject to a glare condition or a snow occlusion condition may also be displayed in an additional display such as the display area 32 of the TD-HUD (see, e.g., FIG. 4B), IPC 34, or center stack display 36. Similarly, for example, if a lane-keep assist notification being displayed in the display area 32 of the TD-HUD is subject to a glare condition, the lane-keep assist notification may also be displayed in an additional display such as IPC 34 or center stack display 36, as well as be repositioned within the display area 32 of the TD-HUD (see, e.g., FIG. 5). The process 600 may then return to block 610 (or block 615) to continue in case vehicle or user conditions change.

If the determination of whether the user has limitations made in block 635 is “yes”, the process 600 moves to a block 650, wherein a computer 104 or central computer 120 may determine whether an adverse visibility condition exists for an outside rear-view mirror 20 of vehicle 102. Such a determination may be based, for example, upon a determination that a user lacks sufficient mobility or visual capability to view one or both outside rear-view mirrors 20 without difficulty. On-board camera data of the user may be used to determine or confirm an earlier determination whether an adverse visibility condition exists for an outside rear-view mirror 20 of vehicle 102.

Upon making the determination that an adverse visibility condition exists for an outside rear-view mirror 20 of vehicle 102 at block 650, the process 600 moves to a block 655, wherein a computer 104 controlling BLIS information being displayed on the outside rear-view mirror 20 caused the BLIS information to be added to another display such as the display area 32 of the TD-HUD (see, e.g., FIG. 4B) or IPC 34 that, for example, do not require user mobility.

In a next block 660, a computer 104 may modify the display of the BLIS information on the additional screen based upon the user limitations, if needed. For example, if user limitations prevent a user from being able to turn their head to view the BLIS information in the outside rear-view mirror 20, the user cannot properly view the outside rear-view mirror 20 for other purposes. Thus, the vehicle computer 104 may modify a first signal for the illuminated BLIS notification from the outside rear-view mirror 20 to include, for example, a second signal to display BLIS video images 42 on display area 32 of the TD-HUD to supplement the BLIS notification symbol, as shown in FIG. 4B. The process 600 may then return to block 610 (or block 615) to continue in case vehicle or user conditions change.

In general, the display of vehicle information on an additional display takes up possible display area on the additional display and reduces interface consistency. As such, the additional display of the vehicle information may generally be done on a temporary basis to address a current adverse visibility condition. In certain implementations, the vehicle information to be displayed on an additional display may be limited to intermittently displayed notifications such as those provided by driver assist systems (e.g., ADAS such as BLIS) and/or those notifications that also include audio and/or haptic indicators so as to not cause confusion due to an inconsistent interface variably displaying elements in multiple locations.

While disclosed above with respect to certain implementations, various other implementations are possible without departing from the current disclosure.

Use of in response to, based on, and upon determining herein indicates a causal relationship, not merely a temporal relationship. Further, all terms used in the claims are intended to be given their plain and ordinary meanings as understood by those skilled in the art unless an explicit indication to the contrary is made herein. Use of the singular articles “a,” “the,” etc. should be read to recite one or more of the indicated elements unless a claim recites an explicit limitation to the contrary.

In the drawings, the same reference numbers indicate the same elements. Further, some or all of these elements could be changed. With regard to the media, processes, systems, methods, etc. described herein, it should be understood that, although the steps of such processes, etc. have been described as occurring according to a certain ordered sequence, unless indicated otherwise or clear from context, such processes could be practiced with the described steps performed in an order other than the order described herein. Likewise, it further should be understood that certain steps could be performed simultaneously, that other steps could be added, or that certain steps described herein could be omitted. In other words, the descriptions of processes herein are provided for the purpose of illustrating certain implementations and should in no way be construed so as to limit the present disclosure.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

1. A system comprising a computer including a processor and a memory, the memory storing instructions executable by the processor programmed to:
transmit a first signal to display vehicle information in a default location of a vehicle upon an occurrence of a condition;
receive data indicative of an adverse visibility condition causing suboptimal perception of the vehicle information in the default location; and
transmit a second signal to display the vehicle information in a secondary location.

2. The system of claim 1, where the adverse visibility condition is:
sun glare or headlight glare on an outside rear-view mirror or a transparent display heads-up display (TD-HUD);
weather-impeded visibility of the outside rear-view mirror; or
user-mobility impeded visibility of the outside rear-view mirror.

3. The system of claim 2, wherein the data includes a vehicle location and travel direction, a sun position, a weather condition, an oncoming headlights position, a following headlights position, a user's range of motion, and/or a user's eye position.

4. The system of claim 3, wherein the data is global positioning system (GPS) data, sun load data, weather condition data, time of day, auto-dimming rearview mirror data, calculated sun position data, forward-facing camera data, rear-facing camera data, and/or user-facing camera data.

5. The system of claim 4, further comprising instructions executable by the processor to determine the adverse visibility condition causing suboptimal perception of the vehicle information using an artificial intelligence (AI) or a machine learning (ML) algorithm.

6. The system of claim 1, wherein:
the vehicle information is a blind spot notification from a blind spot information system (BLIS);
the default location is an outside rear-view mirror; and
the secondary location is an infotainment display, and instrument panel display, or a transparent display heads-up display (TD-HUD).

7. The system of claim 6, wherein the vehicle information is displayed in multiple secondary locations.

8. The system of claim 1, wherein the default location is a transparent display heads-up display (TD-HUD); and
the secondary location is an instrument panel display or an infotainment display.

9. The system of claim 8, wherein the vehicle information in the default location of the TD-HUD is also repositioned to a different position in the TD-HUD.

10. The system of claim 1, further comprising instructions to:
receive input of a user-selection specifying the secondary location for the vehicle information; and
receive data to identify a user for application of the user-selection during operation of the vehicle by the user.

11. A method, comprising:
transmitting a first signal to display vehicle information in a default location of a vehicle upon an occurrence of a condition;
receiving data indicative of an adverse visibility condition causing suboptimal perception of the vehicle information in the default location; and
transmitting a second signal to display the vehicle information in a secondary location.

12. The method of claim 11, where the adverse visibility condition is:
sun glare or headlight glare on an outside rear-view mirror or a transparent display heads-up display (TD-HUD);
weather-impeded visibility of the outside rear-view mirror; or
user-mobility impeded visibility of the outside rear-view mirror.

13. The method of claim 12, wherein the data includes a vehicle location and travel direction, a sun position, a weather condition, an oncoming headlights position, a following headlights position, a user's range of motion, and/or a user's eye position.

14. The method of claim 13, wherein the data is global positioning system (GPS) data, sun load data, weather condition data, time of day, auto-dimming rearview mirror data, calculated sun position data, forward-facing camera data, rear-facing camera data, and/or user-facing camera data.

15. The method of claim 14, further comprising determining the adverse visibility condition causing suboptimal perception of the vehicle information using an artificial intelligence (AI) or a machine learning (ML) algorithm.

16. The method of claim 11, wherein:
the vehicle information is a blind spot notification from a blind spot information system (BLIS);
the default location is an outside rear-view mirror; and
the secondary location is an infotainment display, an instrument panel display, or a transparent display heads-up display (TD-HUD).

17. The method of claim 16, wherein the vehicle information is displayed in multiple secondary locations.

18. The method of claim 11, wherein the default location is a transparent display heads-up display (TD-HUD); and
the secondary location is an instrument panel display or an infotainment display.

19. The method of claim 18, wherein the vehicle information in the default location of the TD-HUD is also repositioned to a different position in the TD-HUD.

20. The method of claim 11, further comprising receiving input of a user-selection specifying the secondary location for the vehicle information; and
receiving data to identify a user for application of the user-selection during operation of the vehicle by the user.
